(19) United States
(12) Patent Application Publication
(10) Pub. No.: US 2007/0078544 A1
(43) Pub. Date: Apr. 5, 2007

(54) SOUND OUTPUT SYSTEM AND METHOD

(75) Inventors: Kuan-Hong Hsieh, Shenzhen (CN); Han-Che Wang, Shenzhen (CN); Shin-Hong Chung, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,397

(22) Filed: Aug. 3, 2006

(30) Foreign Application Priority Data
Sep. 5, 2005 (CN) 200510037133.7

(51) Int. Cl. G06F 17/00

(52) U.S. Cl. 700/94

(57) ABSTRACT

A sound output apparatus is provided. The sound output apparatus includes a memory for storing compensation parameters; a Universal Serial Bus (USB) interface connecting to an external audio signal generating device; a USB controller for reading the compensation parameters from the memory and transferring the compensation parameters to the external audio signal generating device when the external audio signal generating device is connected thereto, and receiving regulated audio signals from the external audio signal generating device according to the compensation parameters; a digital/analog (D/A) converter for converting the regulated audio signals into analog audio signals; an amplifier for amplifying the analog audio signals; and a sound output unit for outputting sounds corresponding to the audio signals.

### CROSS-REFERENCES TO RELATED APPLICATION

This application is incorporated with US patent application No. 11/173130 entitled“sound outputting apparatus having compensation characteristics,” filed on Jul. 1, 2005 herein by reference. Technical Field

The present invention relates to sound output systems and methods, and particularly to a sound output system and method having compensation characteristics.

### General Background

Today, we often listen to a portable device, such as an audio signal generating device, via an earphone. For best listening pleasure, a user needs an earphone that turns audio signals into high fidelity sound.

Humans voices and various musical sounds are various signals having complicated waveforms. The frequency of sound audible to the human ear is generally in the range from 20 Hz to 20 KHz. The frequency range of speech is mainly from 150 Hz to 4 KHz, and the frequency range of musical sound is mainly from 40 Hz to 18 KHz. The energy of the human voice is mostly distributed in the frequency range of 200 Hz-35 KHz. Therefore, in order to correctly play such a wide variety of signals and obtain high quality timbre, an earphone is required to have a wide frequency response characteristic, adequate sound pressure levels, and a large dynamic range. Further, an earphone is also desired to attain a perfect frequency-efficiency characteristic and a perfect frequency-phase delay characteristic. If this is achieved, the output of the earphone maintains high power efficiency and low phase leads or delays as compared to the input of the earphone, accordingly, a listener will hear sounds in high quality timbre. In the following description, phase leads and phase delays are collectively referred to simply as phase delays.

A conventional earphone typically has a frequency-efficiency characteristic and a frequency-phase delay characteristic. These characteristics typically cause much deviation of the output of the earphone from the input of the earphone. That is, the real output is far from an ideal output, and results in poor timbre.

To solve such problem, what is needed is a sound output system and method which have compensation characteristics.

### Summary

A sound output system is provided. The sound output system includes a sound output apparatus and an audio signal generating device. The sound output apparatus includes a memory for storing compensation parameters; a Universal Serial Bus (USB) controller for communicating with the audio signal generating device; a digital/analog (D/A) converter for converting audio signals from the audio signal generating device into analog audio signals; and an amplifier for amplifying the analog audio signals. The audio signal generating device includes a USB controller for communicating with the sound output apparatus, detecting whether the sound output apparatus is connected thereto, transmitting a detection signal for reading the compensation parameters for the sound output apparatus from the memory to the sound output apparatus if the sound output apparatus is connected thereto; and a compensation unit for regulating audio signals according to the compensation parameters, and outputting the regulated audio signals to the sound output apparatus.

A sound output method is also provided. The sound output method includes the steps of: (a) providing a sound output apparatus and an audio signal generating device; (b) detecting whether a sound output apparatus is connected to the audio signal generating device; (c) transmitting compensation parameters from the sound output apparatus to the audio signal generating device if the sound output apparatus is connected to the audio signal generating device; (d) regulating audio signals according to the compensation parameters, and outputting the regulated audio signals to the sound output apparatus; and (e) converting the regulated audio signals into analog audio signals, and outputs sounds corresponding to the analog audio signals.

Another sound output apparatus is further provided. The sound output apparatus includes a memory for storing compensation parameters; a Universal Serial Bus (USB) interface connecting to an external audio signal generating device; a USB controller for reading the compensation parameters from the memory and transferring the compensation parameters to the external audio signal generating device when the external audio signal generating device is connected thereto, and receiving regulated audio signals from the external audio signal generating device according to the compensation parameters; a digital/analog (D/A) converter for converting the regulated audio signals into analog audio signals; an amplifier for amplifying the analog audio signals; and a sound output unit for outputting sounds corresponding to the audio signals.

Other advantages and novel features will become more apparent from the following detailed description when taken in conjunction with the accompanying drawings, in which:

### Brief Description of Drawings

FIG. 1 is a block diagram of a sound output system in accordance with a preferred embodiment of the present invention; and

FIG. 2 is a flowchart of a preferred sound output method by implementing the system in FIG. 1.

### Detailed Description of the Preferred Embodiment

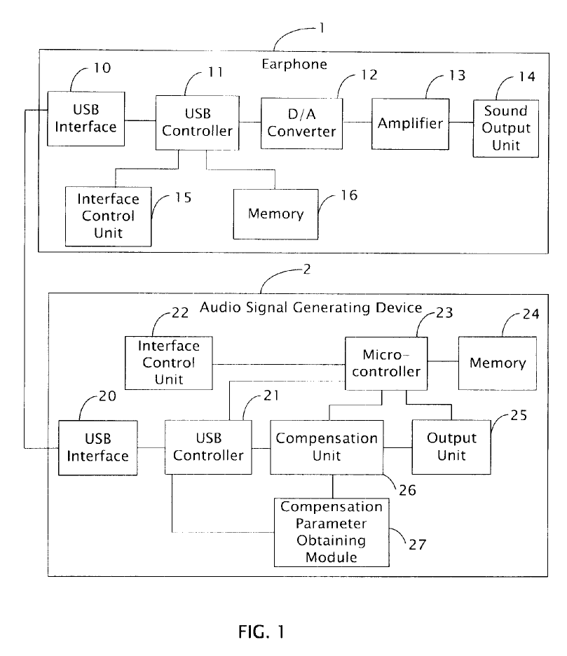

FIG. 1 is a block diagram of a sound output system in accordance with a preferred embodiment of the present invention. The sound output system mainly includes an earphone 1 and an audio signal generating device 2. According to the preferred embodiment, the earphone 1 can be substituted by any other sound output apparatus that can transform audio signals into sounds, such as a speaker or the like. The earphone 1 is used to transform audio signals from a predetermined frequency range into sounds having corresponding sound pressure levels. The audio signal generating device 2 may be an MP3 player, a CD player, a computer, and so on.

The earphone 1 and the audio signal generating device 2 respectively have a Universal Serial Bus (USB) interface 10 and a USB interface 20 for connecting each other.

The earphone 1 further includes a USB controller 11, a digital/analog (D/A) 12, an amplifier 13, a sound output unit 14, and a memory 16. The audio signal generating device 2 further includes a USB controller 21, an interface control unit 22, a micro-controller 23, a memory 24, an output unit 25, a compensation unit 26, and a compensation parameter obtaining module 27.

The earphone 1 has real characteristics per se, including but not limited to a real frequency-efficiency characteristic and a real frequency-phase delay characteristic. These real characteristics cause real outputs of the earphone 1 to deviate from ideal outputs of the earphone 1, thereby resulting in a distortion of the outputs. In order to prevent the distortion, compensation parameters thereupon are introduced and provided in the memory 16. The compensation parameters include a frequency-efficiency compensation parameter and a frequency-phrase delay compensation parameter. Each of the compensation parameters is derived from a testing system (not shown) according to a corresponding real characteristic of the earphone 1, and is adapted to minimize or even eliminate deviations between uncompensated outputs and ideal outputs of the earphone 1. Building principles of the compensation parameters refers to US patent application No. 11/173130. In addition, the memory 16 is further connected to the USB controller 11.

The USB controller 21 detects whether the USB interface 20 is connected to the earphone 1. If so, the USB controller 21 transmits a detection signal to the earphone 1. The USB controller 11 receives the detection signal via the USB interface 10, reads the compensation parameters for the earphone 1 from the memory 16 on the basis of the detection signal, and transmits the compensation parameters to the audio signal generating device 2.

The compensation parameter obtaining module 27 is connected to the USB controller 21 and the compensation unit 26, and is for receiving the compensation parameters via the USB interface 20. The memory 24 is connected to the micro-controller 23, and is for storing audio files and video files. If the interface control unit 22 receives a play operation from a user, the micro-controller 23 controls the output unit 25 to read audio files from the memory 24, and output corresponding audio signals to the compensation unit 26, the compensation unit 26 regulates the audio signals according to the compensation parameters, in order that a listener can approach or even attain ideal output of the earphone 1. The regulated audio signals are output via the USB interface 20 to the earphone 1.

The USB controller 11 receives the regulated audio signals via the USB interface 10, and supplies the regulated audio signals to the D/A converter 12 so as to convert the regulated signals into analog audio signals. The amplifier 13 amplifies the analog audio signals, and outputs sounds corresponding to the analog audio signals via the sound output unit 14.

The earphone 1 further includes an interface control unit 15. The interface control unit 15 is connected with the USB controller 11, and is for receiving operational inputs that include adjusting volume and making song selections. The interface control unit 22 is further used for receiving another operational input for adjusting volume.

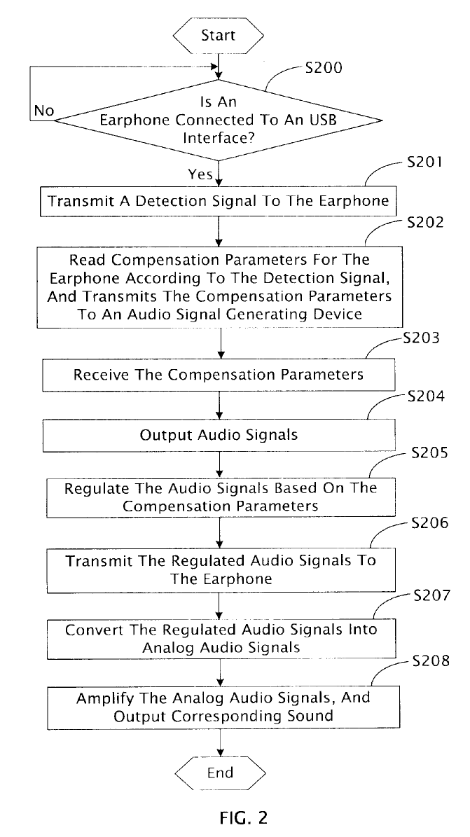

FIG. 2 is a flowchart of a preferred sound output method by implementing the system of FIG. 1. In step S200, the USB controller 21 detects whether an earphone 1 is connected to the USB interface 20. If the earphone 1 is not connected to the USB interface 20, the procedure continues to perform step S200. Otherwise, in step S201, the USB controller 21 transmits a detection signal to the earphone 1. In step S202, the USB controller 11 reads compensation parameters for the earphone 1 from the memory 16 based on the detection signal, and transmits the compensation parameters to the audio signal generating device 2 via the USB interface 10. In step S203, the compensation parameter obtaining module 27 receives the compensation parameters.

In step S204, the output unit 25 outputs audio signals. In step S205, the correcting unit 26 regulates the audio signals according to the compensation parameters, in order to approach or even attain an ideal output of the earphone 1. In step S206, the USB controller 21 transmits the regulated audio signals to the earphone 1 via the USB interface 20. In step S207, the USB controller 11 receives the regulated audio signals via the USB interface 10, and the D/A converter 12 converts the regulated audio signals into analog audio signals. In step S208, the amplifier 13 amplifies the analog audio signals, and the sound output unit 14 outputs sounds corresponding to the analog audio signals.

Although the present invention had been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A sound output system comprising a sound output apparatus and an audio signal generating device, wherein:
the sound output apparatus comprises:
a memory for storing compensation parameters;
a Universal Serial Bus (USB) controller for communicating with the audio signal generating device;
a digital/analog (D/A) converter for converting audio signals from the audio signal generating device into analog audio signals; and
an amplifier for amplifying the analog audio signals; and
the audio signal generating device comprises:
a USB controller for communicating with the sound output apparatus, detecting whether the sound output apparatus is connected thereto, transmitting a detection signal for reading the compensation parameters for the sound output apparatus from the memory to the sound output apparatus if the sound output apparatus is connected thereto; and
a compensation unit for regulating audio signals according to the compensation parameters, and outputting the regulated audio signals to the sound output apparatus.

2. The sound output system according to claim 1, wherein the compensation parameters are built according to real characteristics for the sound output apparatus, and include a frequency-efficiency compensation parameter and a frequency-phrase delay compensation parameter.

3. The sound output system according to claim 1, wherein the USB controller of the sound output apparatus is connected to the memory, for reading compensation parameters from the memory, and transmitting the compensation parameters to the audio signal generating device.

4. The sound output system according to claim 1, wherein the sound output apparatus is an earphone.

5. A sound output method providing a sound output apparatus and an audio signal generating device, the method comprising the steps of:
detecting whether the sound output apparatus is connected to the audio signal generating device;
transmitting compensation parameters from the sound output apparatus to the audio signal generating device if the sound output apparatus is connected to the audio signal generating device;
regulating audio signals according to the compensation parameters, and outputting the regulated audio signals to the sound output apparatus; and
converting the regulated audio signals into analog audio signals, and outputting sounds corresponding to the analog audio signals.

6. The sound output method according to claim 5, wherein the compensation parameters comprise a frequency-efficiency compensation parameter and frequency-phrase delay compensation parameter for the sound output apparatus.

7. The sound output method according to claim 5, wherein the sound output apparatus is an earphone.

8. A sound output apparatus comprising:
a memory for storing compensation parameters;
a Universal Serial Bus (USB) interface connecting to an external audio signal generating device;
a USB controller for reading the compensation parameters from the memory and transferring the compensation parameters to the external audio signal generating device when the external audio signal generating device is connected thereto, and receiving regulated audio signals from the external audio signal generating device according to the compensation parameters;
a digital/analog (D/A) converter for converting the regulated audio signals into analog audio signals;
an amplifier for amplifying the analog audio signals; and
a sound output unit for outputting sounds corresponding to the audio signals.

9. The sound output apparatus 8, wherein the compensation parameters comprise a frequency-efficiency compensation parameter and a frequency-phrase delay compensation parameter.

10. The sound output apparatus 8, wherein the sound output apparatus is an earphone.
